(19) United States
(12) Patent Application Publication
(10) Pub. No.: US 2008/0164799 A1
(43) Pub. Date: Jul. 10, 2008

(54) Optical sheet and display optical filter for increasing color gamut

(75) Inventors: Hye Kyoung Lee, Seoul (KR); In Sung Sohn, Seongnam-si (KR); Sung Nim Jo, Seoul (KR)

Correspondence Address: MCDERMOTT WILL & EMERY LLP, 600 13TH STREET, N.W., WASHINGTON, DC, 20005-3096, US

(73) Assignee: SAMSUNG CORNING CO., LTD.

(21) Appl. No.: 11/987,184

(22) Filed: Nov. 28, 2007

(30) Foreign Application Priority Data
Jan. 5, 2007 (KR) 10-2007-0001461

(51) Int. Cl. H01J 61/40; F21V 11/16

(52) U.S. Cl. 313/112; 362/351

(57) ABSTRACT

An optical sheet and a display optical filter which can increase a contrast ratio in a bright room are provided. The optical sheet for the display optical filter includes a transparent substrate including a plurality of pattern grooves formed thereon; and a light shielding pattern formed of a light absorbent material filled in the plurality of pattern grooves. The light shielding pattern may be formed of a material for either absorbing or shielding light filled in the plurality of pattern grooves. In particular, when an external illuminance increases from 0 Lux to 250 Lux, a reduction rate of a color gamut in CIE color coordinates may be 9% or less with respect to NTSC, and the reduction rate of the color gamut is relatively less in comparison with the case where the optical sheet of the present invention is not used.

### CROSS-REFERENCE TO RELATED APPLICATION

This application claims the benefit of Korean Patent Application No. 10-2007-0001461, filed on Jan. 5, 2007, in the Korean Intellectual Property Office, the disclosure of which is incorporated herein by reference.

### BACKGROUND OF THE INVENTION

1. Field of the Invention

The present invention relates to an optical filter for a display device, and more particularly, to an optical sheet and a display optical filter which can increase a contrast ratio in a bright room.

2. Description of Related Art

A Plasma Display Panel (PDP) apparatus displays an image using a gas discharging phenomenon, and has excellent display characteristics such as display volume, brightness, contrast ratio, afterimage, viewing angle, and the like. The PDP apparatus is a self-emitting display device which can be easily manufactured to be in a large-size and to be thin, and has appropriate properties for a high-quality digital television, and hence it has been highly regarded as a substitute display device for a conventional cathode ray tube (CRT).

In general, the PDP apparatus generates a gas discharge between electrodes by a direct current (DC) voltage or an alternating current (AC) voltage which are supplied to electrodes. Here, ultraviolet light is generated. Then, a phosphor is exited by ultraviolet light, thereby emitting light.

However, the PDP apparatus has a defect in that an amount of emitted electromagnetic (EM) radiation and near infrared (NI) radiation generated in the PDP apparatus is great in terms of the driving characteristic, and thus it may have harmful effects on human bodies, and cause sensitive equipments such as wireless telephones, remote controls, and the like, to malfunction. Also, surface reflectivity of the phosphor is great, and color purity due to orange light emitted from helium (He), or xenon (Xe) used as a sealing gas is lower than the CRT.

Therefore, in order to use the PDP apparatus, it is required to prevent emission of EM radiation and NI radiation emitted from the PDP apparatus from increasing to more than a predetermined level. In this manner, a filter in which functional films are stacked and positioned on a front surface of the PDP apparatus is referred to as a PDP filter.

The PDP apparatus has functions such as Electromagnetic Interference (EMI) shielding function, NI radiation (NIR) shielding function for regulating a remote control and preventing infrared rays from causing communication failure, enhancement of color purity function in which orange light emitted from a neon gas, used as a discharging gas of the PDP apparatus, is absorbed and thereby enhancing color purity and also enhancing anti-reflection functionality of preventing external light from being reflected. Currently, the PDP apparatus has an external light absorption function for enhancing a contrast ratio in a bright room.

An optical film having the external light absorption function is used for preventing external light from entering into a discharging cell of the PDP. However, as brightness of external light is increasing, color reproductivity is deteriorated.

### SUMMARY OF THE INVENTION

An aspect of the present invention provides an optical sheet and a display optical filter which maintains superior color reproductivity in a bright room.

According to an aspect of the present invention, there is provided an optical sheet for a display optical filter comprising a transparent substrate including a plurality of pattern grooves formed thereon; and a light shielding pattern formed of a light absorbent material filled in the plurality of pattern grooves. In this instance, a film made of a transparent material such as acrylic, polycarbonate (PC), polyethylene terephthalate (PET), and the like may be used as the transparent substrate. The plurality of pattern grooves may be formed on the transparent substrate with a predetermined size and interval. The light shielding pattern may be formed of a material for either absorbing or shielding light filled in the plurality of pattern grooves.

In particular, when an external illuminance increases from 0 Lux to 250 Lux, a reduction rate of a color gamut in Commission International de l'Eclairage (CIE) color coordinates may be 9% or less, and the reduction rate of the color gamut is relatively less in comparison with the case where the optical sheet of the present invention is not used.

For reference, the light shielding pattern may be formed in a variety shapes such as a trapezoid, a wedge, a triangle, a semi-sphere, and the like, and black carbon, etc., may be used as the shielding material.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a cross-sectional view illustrating an optical filter and an optical sheet according to an exemplary embodiment of the present invention;

FIG. 2 is a diagram illustrating change in a color gamut according to Commission International de l'Eclairage (CIE) color coordinates; and

FIG. 3 is a diagram illustrating a reduction rate of color gamut based on a measured illuminance in order to compare a display optical filter of FIG. 1 a comparative example 1.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

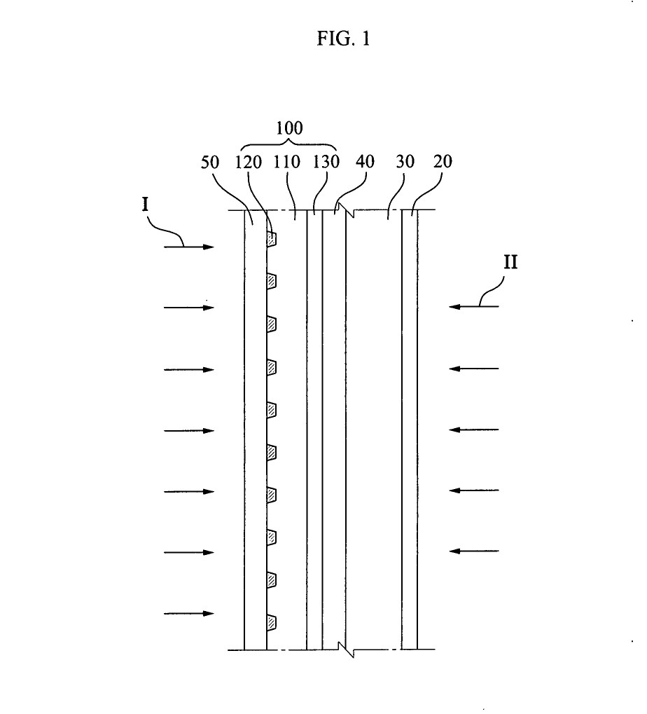

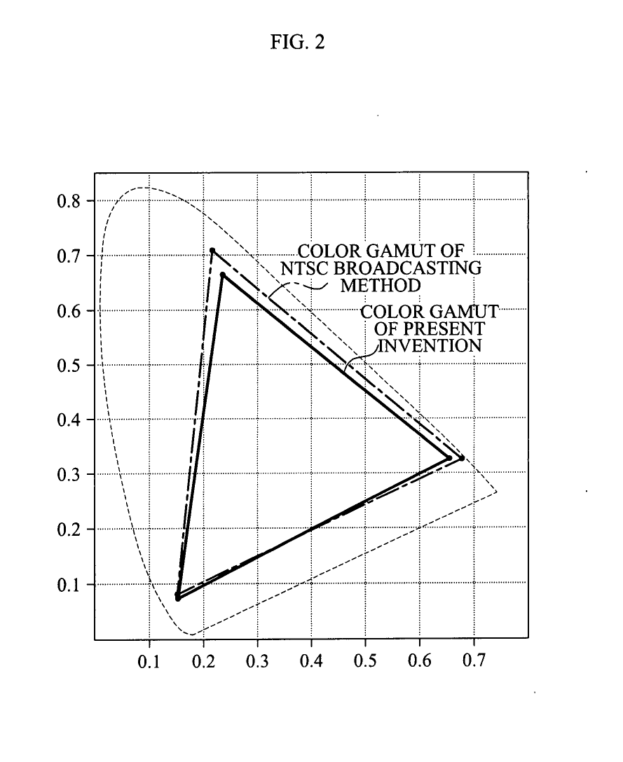

FIG. 1 is a cross-sectional view illustrating an optical filter and an optical sheet according to an exemplary embodiment of the present invention, and FIG. 2 is a diagram illustrating change in a color gamut according to Commission International de l'Eclairage (CIE) color coordinates.

Referring to FIGS. I and 2, an optical filter according to the exemplary embodiment of the present invention is formed by stacking an anti-reflection film 20, a glass base 30, an electromagnetic wave-shielding film 40, a light-shielding optical sheet 100, and a color correction film 50 in the stated order. The light-shielding optical sheet 100 is provided together with the electromagnetic wave-shielding film 40 formed on a surface of the glass base 30. The anti-reflection film 20 of the optical filter is mounted toward the outside of a display device such as a PDP. Incident light (I) internally generated passes through the anti-reflection film 20 via the color correction film 50, and consequently is transmitted to a viewer.

However, the optical filter may be formed of at least any one of the anti-reflection film 20, the glass base 30, the electromagnetic-shielding film 40, the light-shielding optical sheet 100, and the color correction film 50, although it is formed by stacking the above-mentioned films in the stated order in the present exemplary embodiment of the invention. Alternatively, the order may be changed to be stacked in various manners.

The light-shielding optical sheet 100 according to the present embodiment of the invention includes a transparent film 110 having a plurality of pattern grooves formed on a surface of the transparent film 110 and a light-shielding pattern 120. The light-shielding pattern 120 is provided such that each of the plurality of pattern grooves is formed into a trapezoidal shape and a light absorbent material is filled in the plurality of pattern grooves.

The transparent film 110 may be used as a transparent substrate, and whose material may be polyethylene terephthalate (hereinafter, referred to as ‘PET’) acryl, polycarbonate (hereinafter, referred to as ‘PC’), urethane acrylate, polyester, epoxy acrylate, brominate acrylate, and the like.

Since nearly all of external light (II) are generated from light fittings generally installed in a ceiling, the external light (II) may be projected from above of a display apparatus. Thus, the light-shielding pattern 120 is generally formed in a horizontal direction. In order to improve light-shielding efficiency, the light-shielding pattern 120 is formed in a wedge-shape. This is desirable for absorption efficiency because a light absorbent area is relatively large. In this instance, the light-shielding pattern 120 having a wedge-shaped cross sectional area effectively absorbs external light in a bright room, thereby improving contrast ratio in a bright room.

Various methods for forming a plurality of pattern grooves on a transparent film may be used. According to one method, a UV hardener is coated on a surface of a transparent film, a protrusive wedge-shaped article is pressurized on the surface coated with the UV hardener, whereby a plurality of grooves having a perfect mirror image of the protrusive wedge-shape is formed on the transparent film. Subsequently, the transparent film is exposed to ultraviolet rays, and consequently a plurality of pattern grooves formed on the transparent film is obtained.

Alternatively, for forming a plurality of grooves on the transparent film, a heated die may be used. Specifically, a desired-shaped groove may be formed by pressurizing the heated die on a thermoplastic resin through a heat press method. Also, a casting method in which a thermoplastic resin composition is poured into the die and hardened, thereby forming a groove corresponding to the die, may be used. An injection molding method similar to the above mentioned-methods may be also used.

As illustrated in FIG. 1, the transparent film 110 may be formed of a groove like a concave-lens. A resin including a colorant, such as a black pigment, a carbon black, and the like, which are light absorbent materials, is filled in the groove of the transparent film 110 using a wiping method, and hardened by ultraviolet rays. Here, a mixed material, in which a carbon nanotube (CNT), a copper oxide, an indium tin oxide (ITO), and the like, is mixed with a highly conductive polymer, may be used as the colorant, thereby achieving an Electro Magnetic Interference (EMI) shielding function. Here, a width of the light-shielding pattern 120 may be 10 to 50 μm.

After forming the light-shielding pattern 120 on a surface of the transparent film 110, a supporter 130 may be formed on the opposite surface of the transparent film 110. Specifically, the transparent film 110 with the light-shielding pattern 120 may be directly formed on the electromagnetic wave-shielding film 40 or another filter base. However, as illustrated in FIG. 1, the transparent film 110 is formed on the supporter 130, and then the transparent film 110 with the supporter 130 is adhered on the electromagnetic wave-shielding film 40. The supporter 130 functions to support the transparent film 110 with the light-shielding pattern 120.

Referring again to FIG. 1, for manufacturing the optical sheet 100, a urethane-acrylic UV-cured resin is coated on a surface of the optical PET transparent film 110 with a coated thickness of 200 μm by using a micro via. Next, the pattern groove is formed using an asymmetric wedge-shaped die, and then UV-hardened. The carbon black having an average particle size about 50 μm allows a black ink which is dispersed at about 3 wt. % to be mixed with a UV hardening resin, thereby manufacturing a black resin with a solid content of about 20%. The wedge-shaped pattern grooves are filled with a light absorbent material through a wiping method in which the resin with the black ink mixed therewith is poured on the transparent film 110 with the wedge-shaped grooves formed thereon, and then the outer surface of the transparent film is wiped.

Referring to FIG. 2, CIE color coordinates that was established by Commission International de l'Eclairage (hereinafter referred to as ‘CIE’) in 1976 is illustrated. The CIE color coordinates defined by the CIE may be used for specifying colors. There are various kinds of color specification systems other than the CIE color coordinates. Since colors of the CIE color coordinates are expressed in numerals in a standard light source, objectivity for specifying colors is realized. In general, the CIE color coordinates specifies colors in a three-dimensional space characterized by three orthogonal axes, that is, xyz coordinate axes. The z-axis is defined with ‘L’ value specifying brightness, the x-axis is defined with ‘a’ value specifying a red color (positive direction) and a green color (negative direction), and the y-axis is defined with ‘b’ value specifying a yellow color (positive direction) and a blue color (negative direction). In FIG. 2, chromaticity coordinate values corresponding to only xy-axes are illustrated. Also, in FIG. 2, a color gamut defined with three primary colors that are a red color (R), a green color (G), and a blue color (B) (hereinafter referred to as ‘RGB’) and a color gamut defined with a National Television System Committee (hereinafter referred to as ‘NTSC’) broadcasting method are illustrated, respectively.

In FIG. 2, Example 1 is obtained using the display optical filter illustrated in FIG. 1, and Comparative Example 1 is obtained using a display optical filter without the optical sheet 100. Table 1 and Table 2 show changes of the color gamut and chromaticity coordinates depending on a measured illuminance.

TABLE 1

| | Color gamut | |
|---|---|---|
| measured illuminance | (in comparison to NTSC: %) | |
| (Lux) | Comparative Example 1 | Example 1 |
| 0 | 94.2 | 95.2 |
| 150 | 84.9 | 91.2 |
| 250 | 81.4 | 88.5 |
| Reduction gradient of color | 0.522 | 0.267 |
| gamut | | |

TABLE 2

| | | |
|---|---|---|
| 0~250 Lux | Comparative | |
| Change in | Example 1 | Example 1 |

| CIE(x, y) | Δx | Δy | Δx | Δy |
|---|---|---|---|---|
| R | −0.029 | 0.001 | −0.015 | 0.000 |
| G | 0.006 | −0.026 | 0.003 | −0.014 |
| B | 0.008 | 0.014 | 0.004 | 0.007 |

| | | |
|---|---|---|
| change in color | −0.0203 | −0.0106 |
| gamut | | |

Referring to Table 1, when assuming that a reproducible color gamut obtained by the NTSC broadcasting method is 100, each color gamut observed in Example 1 and Comparative Example 1 was expressed in numerals to be compared with each other. Also, Table 2 shows changes in RGB values of the CIE color coordinates in Example 1 and Comparative Example 1, when the measured illuminance was increased from 0 Lux to 250 Lux.

Referring to Tables 1 and 2, when the measured illuminance was 0 Lux, 150 Lux, and 250 Lux, the color gamut in Comparative Example 1 was 94.2%, 84.9%, and 81.4%, with respect to the NTSC, respectively. Under the same measured illuminance as Comparative Example 1, the color gamut in Example 1 was 95.2%, 91.2%, 88.5% with respect to the NTSC, respectively. Specifically, when the external measured illuminance was increased from 0 Lux to 250 Lux, the color gamut of the CIE color coordinates was decreased by about 6.7%, which was considered as a relatively less decreasing rate of about 9% or less.

When the external illuminance was increased from 0 Lux to 250 Lux, an amount of displacement due to change in a chromaticity coordinate representing R in the CIE color coordinates indicated −0.015 with respect to x axis, which corresponds to −0.020≦Δx≦0. Also, the amount of displacement indicated 0.000 with respect to y-axis, which corresponds to −0.001≦□y≦0.001.

When the external illuminance was increased from 0 Lux to 250 Lux, an amount of displacement due to change in a chromaticity coordinate representing G in the CIE color coordinates indicated 0.003 with respect to x axis, which corresponds to 0≦Δx≦0.005. Also, the amount of displacement indicated −0.014 with respect to y axis, which corresponds to −0.020≦□y≦0.020.

When the external illuminance was increased from 0 Lux to 250 Lux, an amount of displacement due to change in a chromaticity coordinate representing B in the CIE color coordinates indicated 0.004 with respect to x axis, which corresponds to −0.005≦□x≦0.005. Also, the amount of displacement indicated 0.007 with respect to y axis, which corresponds to −0.010≦□y≦0.010.

When comparing reduction gradients of respective color gamuts, a reduction gradient of the color gamut in Example 1 was about 0.267, while a reduction gradient of the color gamut in Comparative Example 1 was about 0.522. Specifically, when the external illuminance was increased from 0 Lux to 250 Lux, a reduction gradient of the color gamut in the CIE color coordinates was 0.267, which corresponds to a range of 0 to 0.5.

As can be seen from the above, in a substantially identical condition (e.g. identical measured illuminance), a color gamut in Example 1 is greater than that in Comparative Example 1. Also, as the measured illuminance increases, a reduction gradient of the color gamut in Example 1 is less than that in Comparative Example 1.

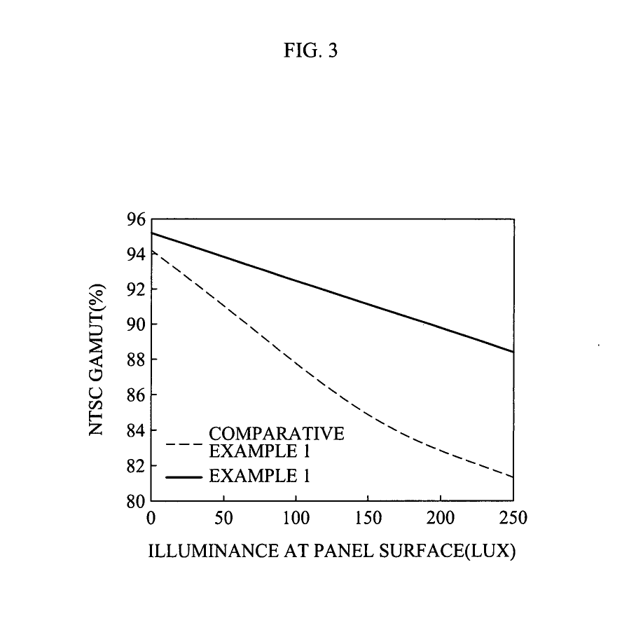

FIG. 3 is a diagram illustrating a reduction rate of a color gamut based on a measured illuminance in order to compare a display optical filter of FIG. 1 with a comparative example 1. Referring to FIG. 3, a reduction gradient of the color gamut in Comparative Example 1 is greater than that in Example 1.

That is, according to the present exemplary embodiment of the invention, when the measured illuminance is increased, the color gamut is decreased with a relatively less reduction rate in comparison with the color gamut in Comparative Example 1. Also, according to the present exemplary embodiment of the invention, relatively high color-purity and image quality in a bright room are achieved in comparison with Comparative Example 1. In general, a color gamut is reduced with an increase in the external illuminance. According to the present exemplary embodiment of the invention, a reduction rate of the color gamut is decreased by about 50% in comparison with other conventional filters.

As described above, according to the present invention, superior color reproductivity in a bright room can be maintained, and a reduction rate of the color gamut can be decreased with an increase in the measured illuminance in comparison with conventional optical filter or sheet. Even though a color gamut is generally reduced with an increase in an external illuminance, the reduction rate of the color gamut according to the present invention is decreased to about 50% in comparison with other conventional filters.

Also, relatively high color-purity and image quality in a bright room can be achieved in comparison with a conventional optical filter or sheet.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An optical sheet for a display optical filter, comprising:
a transparent substrate including a plurality of pattern grooves formed thereon; and
a light shielding pattern formed of a light absorbent material filled in the plurality of pattern grooves,
wherein, when an external illuminance increases from 0 Lux to 250 Lux, a reduction rate of a color gamut in Commission International de l'Eclairage (CIE) color coordinates is less than or equal to 9%.

2. The optical sheet of claim 1, wherein, when an external illuminance increases from 0 Lux to 250 Lux, a chromaticity coordinate representing a red color (R) in the CIE color coordinates is changed to be in ranges of −0.020≦Δx≦0 with respect to x-axis, and −0.001≦Δy≦0.001 with respect to y-axis, respectively.

3. The optical sheet of claim 1, wherein, when an external illuminance increases from 0 Lux to 250 Lux, a chromaticity coordinate representing a green color (G) in the CIE color coordinates is changed to be in ranges of 0≦Δx≦0.005 with respect to x-axis, and −0.020≦Δy≦0.020 with respect to y-axis, respectively.

4. The optical sheet of claim 1, wherein, when an external illuminance increases from 0 Lux to 250 Lux, a chromaticity coordinate representing a blue color (B) in the CIE color coordinates is changed to be in ranges of −0.005≦Δx≦0.005 with respect to x-axis, and −0.010≦Δy≦0.010 with respect to y-axis, respectively.

5. The optical sheet of claim 1, wherein, when an external illuminance increases from 0 Lux to 250 Lux, a gradient change of a color gamut in the CIE color coordinates is between 0 and 0.5.

6. A display optical filter including a plurality of films, comprising:
an optical sheet as one of the plurality of films,
wherein the optical sheet comprises a transparent substrate including a plurality of pattern grooves formed thereon and a light shielding pattern formed of a light absorbent material filled in the plurality of pattern grooves,
wherein, when an external illuminance increases from 0 Lux to 250 Lux, a reduction rate in a color gamut in CIE color coordinates is less than or equal to 9%.

7. The optical filter of claim 6,
wherein, when an external illuminance increases from 0 Lux to 250 Lux, a chromaticity coordinate representing R in the CIE color coordinates is changed to be in ranges of −0.020≦Δx≦0.020 with respect to x-axis, and −0.001≦Δy≦0.001 with respect to y-axis, respectively,
a chromaticity coordinate representing G in the CIE color coordinates is changed to be in ranges of −0.005≦Δx≦0.005 with respect to x-axis, and −0.020≦Δy≦0.020 with respect to y-axis, respectively, and
a chromaticity coordinate representing B in the CIE color coordinates is changed to be in ranges of −0.005≦Δx≦0.005 with respect to x-axis, and −0.010≦Δy≦0.010 with respect to y-axis, respectively.

8. The optical filter of claim 6, wherein, when an external illuminance increases from 0 Lux to 250 Lux, a gradient change of a color gamut in the CIE color coordinates is between 0 and 0.5.
